(19) United States
(12) Patent Application Publication
(10) Pub. No.: US 2020/0325973 A1
(43) Pub. Date: Oct. 15, 2020

(54) GEARLESS DIFFERENTIAL

(71) Applicants: Paul G McKinnon, Brigham City, UT (US); Lane McKinnon, Brigham City, UT (US)

(72) Inventors: Paul G McKinnon, Brigham City, UT (US); Lane McKinnon, Brigham City, UT (US)

(73) Assignee: Team, Inc. dba Tool Engineering & Manufacturing Company, Salt Lake City, UT (US)

(21) Appl. No.: 16/381,691

(22) Filed: Apr. 11, 2019

(51) Int. Cl. F16H 48/16; F16H 48/14; F16H 48/40

(52) U.S. Cl. CPC F16H 48/16; F16H 48/40; F16H 48/147

(57) ABSTRACT

A gearless differential for distributing power from a motor to two follower shafts with ends connected to opposite wheels and to opposed outer disks held in position with a journal mounted casing having corresponding identical regular polygonal raceways with asymmetric sections surrounding a central drive disk there between with equidistant radial slots each holding one cylinder or roller bearing to radially reciprocate as they race along the raceways in a slippage mode where one wheel loses traction; and in a drive mode where the central drive disk power input drives both outer disks connected to the two follower shafts transferring torque evenly to both wheels so there is no movement of the cylinders or roller bearings in the raceways.

### BACKGROUND OF THE INVENTION

### Field of Invention

The present invention relates to differentials. In particular, it relates to a gearless differential for distributing power from a motor to two follower shafts with first ends connected to opposite wheels and second ends connected to opposed outer rotating disks having corresponding identical triangular raceways surrounding a central drive disk there between with equidistant radial slots holding cylinders or roller bearings to radially reciprocate as they race along the raceways in a slippage mode where one wheel loses traction; and in a drive mode where the central drive disk power input drives both outer disks connected to the two follower shafts transferring torque evenly to both wheels so there is no movement of the roller bearings or cylinders in the raceways.

### Description of Related Art

A number of gearless differentials are known, such as Allen, U.S. Pat. No. 1,446,325 issued Feb. 20, 1923 using a driving casing with having slots in it periphery and provided with hubs adapted to be journaled in fixed bearings; a spider within said casing having lugs loosely fitting certain of said slots and provided with a hub, and two drive members having a set of ratchet teeth and a hub journaled in the said hubs of the casing and of the spider; oppositely facing pawls carried by said spider to engage said teeth; and pawl actuators pivotally carried by the spider and having lugs snugly fitting others of said slots. The pawl construction providing unnecessary friction during operation.

Ford, U.S. Pat. No. 1,336,950 issued Apr. 13, 1920 is another gearless differential using a cylindrical members attached to a live axle with a cam mounted within the cylinder and secured to a second live axle, with a plurality of wedges adapted to occupy space between said cylinder and said cam members with a means for actuating the wedges consisting of a cage having recesses adapted to contain the various wedges, and a means for rotating said cage.

Ford, U.S. Pat. No. 1,897,555 issued Jan. 21, 1932 discloses a gearless differential using frusto-conical wedging rollers pushing against a track with different elevations.

Szekely, U.S. Pat. No. 2,019,367 issued Oct. 29, 1935 discloses an overrunning gearless differential comprising a rigid rotatable structure including a rotatable member having a pair of axially extending protections with peripheral clutch cam surfaces and a rotatable house, a pair of axle members having clutch rings located in said housing and having circular internal surfaces surrounding said cam surfaces, two sets of independent clutch devices located between said surfaces, resilient means fixedly mounted to each projection for coordinating the corresponding said clutch devices, and independent bearings between said projections and rings adjacent said rotatable member, and between said housing and axle members whereby bearings are provided at both axial ends of said set of clutch devices.

Summy, U.S. Pat. No. 2,338,215 issued Apr. 11, 1945 discloses a gearless differential employing a pair of transversely divided housing sections, means uniting the said sections to form a housing assembly, an external ring gear fixed to one of the said sections, the interior chamber of each section having an annular groove, a bearing sleeve extending axially from each bearing section, a pair of circular complementary hubs rotatably fitted in the housing sections, an axle engaging sleeve of reduced external diameter projecting axially from each hub and rotatably mounted in each section sleeve, each of said hubs having a plurality of arcuate circumferential grooves in its exterior periphery disposed as circumferentially spaced intervals, and a clutch ball mounted in each arcuate groove and corresponding annual groove to provide over-running connection between the housing sections and the hubs.

Decker, U.S. Pat. No. 2,841,036 issued Jul. 1, 1958 discloses a gearless differential with tubular driving cage, a plurality of longitudinal slots in the driving cage, a plurality of ball bearings in the slots, a first drive shave having intersecting, external, continuous tracks alternately extending their courses toward opposite ends of the first drive shaft being disposed with its tracks within the driving cage and in camming relation with the ball bearings in the slots, a second drive shaft having a tubular end thereon and positioned over the driving cage; parallel, internal, continuous tracks in the tubular end of the second drive shaft, alternatively extending their courses toward opposite ends of the second drive shaft, and said track being disposed in camming relation with the ball bearings in the slots whereby the rotation of the driving cage impels the ball bearings into camming relation with the internal and external tracks thereby producing rotation of the drive shafts, and said tracks on the first and second drive shafts, each having a corresponding number of alternations of courses.

Ohta, U.S. Pat. No. 6,780,133 issued Aug. 24, 2004 differential gear including a cylindrical power transmission member, two cam members accommodated in an inner space of the power transmission member, and a plurality of cam follower members. Each of the Cam follower elements is fitted to a respective one of a plurality of engagement grooves formed on an inner peripheral surface of the power transmission member in an axially longitudinal direction such that each of the cam follower elements partially sticks out of the inner space. The cam follower elements are interposed between cam lobes formed on opposing surfaces of the two cam members. Drive power of the power transmission member is distributed to the two cam members via the cam follower elements.

Tsiriggakis, U.S. Pat. No. 4,509,388 issued Apr. 9, 1985 discloses differential gear including a power-transmission element, e.g. gear, which distributes rotation from a drive motor to two shafts by way of a gear connection. Two identically designed cam-track disks are opposite the shafts, are mounted coaxially to the power-transmission element, can be turned relative to it. The cam-track disks each have at least one inner and one outer cam track on the surfaces facing each other. The cam tracks have variable heights in axial directions, distributed along the peripheries and are connected by at least one rolling member which rolls on the cam tracks of both cam-track disks. The rolling member is connect to the power-transmission element, in such a way that the axis of rotation of the rolling member is positioned radially to the power-transmission element and, at the same time, the rolling member can be moved crosswise to the rotational axis.

Wildhaber, U.S. Pat. No. 2,790,334 issued Apr. 30, 1957 discloses a gearless differential having two coaxial cam members, a cage coaxial with the cam members, and a plurality of radially slidable parts mounted and held in said cage and engaging said cam members, in which power is applied to one of said cam members while the other cam members and cage are connected with the driven road wheels of a vehicle.

Cited for general interest are Sheckler, U.S. Pat. No. 1,437,453 issued Dec. 5, 1922, which employs paws adapted to engage toothed wheels connected to axles and springs connected to a drive member and to the pawls for swing the pawls as direction of drive is reversed.

Seeck, U.S. Pat. No. 1,388,069 issued Aug. 16, 1921 discloses a gearless differential power transmission having a driven case, a divided axle whose sections are journaled, in the case, a crank-element on each axle-section, transmission members reciprocate in the case on lines radial to the axis of rotation of the case, and perpendicular to each other, and devices mounted on the eccentric portions of said crank-elements and reciprocating in said transmission-members.

Ford, U.S. Pat. No. 1,365,586 issued Jan. 11, 1921 discloses a gearless differential transmission mechanism with a divided axle whose sections are journaled in the transmission-case with a crank-element mounted on each axle section with means to co-operatively connect crank elements jointly driven by the rotation of the transmission case.

Lavier, U.S. Pat. No. 1,337,480 issued Apr. 20, 1920 discloses a Gearless Differential with ratchet gears for driving a vehicle forward via a casing supporting divided axles.

Ziegler, U.S. Pat. No. 1,463,356 issued Jul. 31, 1923 discloses a gearless differential transmission mechanism in combination with aligned shaft section with blocks slidably mounted adapted to be engaged by eccentric portions of the head and sidewall of the casing member provided with an eccentrically disposed surface adapted to be engaged by the outer end of the blocks.

Thomson, U.S. Pat. No. 1,955,208 issued Jun. 10, 1933 discloses a gearless differential having a locking differential gear with rotator adapted to be rotated from a source of supply, an axle disc at each end of the rotor, said rotor having an endless path communicating with both discs, a plurality of members adapted to transmit the drive from the rotor to both discs and to be transferred from one disc through said path to the other when driving one disc faster than the other, and means carried by said rotor for impeding the passage of said members along the path.

None provide a gearless differential for distributing power from a motor to two follower shafts with first ends connected to opposite wheels and second ends to opposed outer disks having corresponding identical triangular raceways surrounding a central drive disk there between. The central drive disk has six equidistant radial slots holding cylinders or roller bearings to radially reciprocate as they race along the raceways in a slippage mode where one wheel loses traction; and in a drive mode where the central drive disk power input drives both outer disks connected to the two follower shafts transferring torque evenly to both wheels so there is no movement of the roller bearings or cylinders in the raceways. The device below provides such an invention.

### BRIEF SUMMARY OF THE INVENTION

The present invention comprises a gearless differential for distributing power from a motor to two follower shafts connected to opposite wheels to permit the two aligned follower shafts to rotate differently. It comprises a central drive disk with extended axle pin having a perimeter with structure driven by a motor drive chain or pulley or other engagement mechanisms. It has six or more equidistant radial slots into which centers of cylinders or roller bearings radially reciprocate. The central drive disk is located between two opposed identical corresponding outer disks rotatably mounted on each side of the central drive disk to rotate on the axle pin. The outer drive disk exteriors are each affixed to a follower shaft connected to respective opposite wheels. The outer disks have identical interiors each with corresponding aligned regular convex polygon shaped raceways with equal sides (n) centered about the axle pin, where n≥3. Each regular convex polygonal raceway has an asymmetric extension raceway section. The matching opposed raceways are sized to accommodate ends of the slotted cylinders or roller bearings to race along the raceways as they reciprocate radially in the central drive disk radial slots in a slippage mode where one wheel loses traction. In the drive mode, the central drive disk power input drives both outer disks connected to the two follower shafts transferring torque evenly to both wheels with no movement of the cylinders or roller bearings in the raceways.

In one embodiment, the regular convex polygon has triangular shaped raceways with vertices aligned where each triangular side of the raceway has an asymmetric extension raceway section. The opposed raceways are sized to accommodate ends of the slotted cylinders or roller bearings to race along the raceways as they reciprocate radially in the central drive disk radial slots in a slippage mode where one wheel loses traction. In the drive mode, the central drive disk power input drives both outer disks connected to the two follower shafts transferring torque evenly to both wheels with no movement of the cylinders or roller bearings in the raceways.

The triangular geometric shaped raceway with six roller bearings in an example only. Any regular convex polygonal shaped raceway centered around the axle pin may be used, provided that somewhere around the raceway is an extension of the raceway path that is not symmetrical around a radial line of the geometric shape for the ends of the cylinders or roller bearings to travel.

The number of slots in the central drive disk is the number of convex polygonal sides times 2, so for a hexagon, for example, the number of slots is twelve, each containing a cylinder or roller bearing to travel along the hexagonal raceways.

In one embodiment of the gearless differential, a shifting cage is included to engage and disengage the differential. The left side output of the outer disk has a triangular raceway described above into which the ends of the cylinders or roller bearings travel. The central drive disk of the drive differential has six radial slots into which the centers of ball bearings or cylinders are fitted to radially travel. The right side output of the outer disk has an identically aligned triangular raceway to that of the left side output so that the ends of the cylinders or roller bearings travel in the same loci defined by the said triangular raceways in a slippage or drive mode.

Usually associated with the gearless differential is a reduction drive unit, such as the stepping gear described below. The motor input shaft torque to the reduction drive unit enters the stepping gear and is reduced before activating the drive differential.

In one embodiment, the reduction drive unit comprises an eccentric dual stepping gear roller bearing system comprising an eccentric input drive, such as a pulley drive, affixed to a drive shaft, and an output drive shaft. Positioned between the eccentric input drive and the output drive is the eccentric dual stepping gear roller bearing system. It has an output gear mounted within a gear ring with a circumferential housing defining a cylindrical interior with a portal leading into said cylindrical interior and sized to accommodate the output shaft and output gear. The gear ring includes structure to hold a circular peripheral exterior row of a plurality of roller bearings in fixed equidistant positions around the interior perimeter in a manner which exposes the surfaces of the roller bearings.

The output gear is attached to the output shaft and positioned to fit and rotate within the gear ring interior. The output gear has peripheral teeth-like structure adapted to hold a circular interior row of a plurality of roller bearings in fixed equidistance circular positions around the output shaft in a different planer alignment relative to that of the exterior row of roller bearings. In addition, the number of interior roller bearings in the interior row is less than the number of roller bearings in the exterior row.

At least one eccentric stepping gear with two exterior and interior stepping gears having different radii are joined off-center on top of one another so that their respective teeth are somewhat concentrically aligned. The eccentric stepping gear is then eccentrically attached to the input drive shaft and positioned within the cylindrical interior of the gear ring so that the teeth of the exterior stepping gear contacts the roller bearings in the exterior row, and the teeth of the interior eccentric stepping gear contacts the roller bearings in the exterior row of the output gear. When activated by the eccentric drive shaft, the eccentric stepping gear moves such that the exterior eccentric stepping gear teeth push against the roller bearings in the exterior row in a stepping gear like motion causing the joined interior stepping gear teeth to push against and sequentially move the interior roller bearings to rotate the output gear, when activated by the drive shaft. The different numbers of roller bearings, the differences in the radii and diameters of the exterior and interior rows of roller bearings, and the different sizes of roller bearings reduce the rotation of the output gear and the output shaft.

Encasement structure, such as a circumferential housing with portals leading into an interior sized to accommodate the eccentric input drive shaft and output drive shaft is structured to rotationally secure within the cylindrical interior of the gear ring the stepping gear eccentrically affixed to the eccentric input drive shaft and the output gear affixed to the output shaft and positioned such that the gear teeth act upon the first and second rows of roller bearings to reduce the output as described above.

The encasement structure may be of single piece construction or have multiple parts, such as a series of plates with portals to accommodate the eccentric input drive shaft and the output drive shaft, and an interior to accommodate the output gear and stepping gear. Means such as bolts, screws, welds, fasteners, etc. secure the various parts of the encasement structure to secure operationally the eccentric combination stepping gears and output gears within the cylindrical interior to reduce the eccentric drive shaft interior into a gear reduced output for the output shaft.

The dual exterior and interior eccentric stepping gears have different numbers of gear teeth structured as cusps to sequentially contact and push against the roller bearings. The stepping-like motion of the interior and exterior eccentric stepping gear teeth sequentially contact approximately ⅓ of the exterior and interior rows of roller bearings at any given time.

The number of exterior roller bearings is greater than the number of interior roller bearings with the number selected to effectuate the desired gear reduction ratio. The roller bearings may be cylindrical or ball bearings, depending upon the application. Preferred roller bearings are ball bearings as they may rotate in different directions to minimize frictional losses, but cylindrical roller bearings provide added directional stability and a greater wear surface. These roller bearings are replaceable and provide an inexpensive gear construction.

In one embodiment, the number of exterior roller bearings is two more than the number of interior roller bearings. The size of the diameter of the interior row of roller bearings and the exterior row of roller bearings may differ and are selected to provide the desired gear reduction. In addition, the size of the gear diameters may be adjusted so that diameter of the interior row of roller bearings and the diameter of the exterior row of roller bearings are selected to provide the desired gear reduction in excess of 10:1. The device provides particularly good gear reduction of 10:1; 62:1, 70:1 on up to 500:1.

The throw mounts of the exterior and interior eccentric stepping gears are selected so that the stepping gear teeth contact approximately one-third of the roller bearings of each row at a given time.

The advantage of this eccentric dual stepping gear roller bearing system is that it provides an inexpensive gear construction requiring minimal amount of lubrication depending upon tolerances. Bearings may be easily replaced, depending upon wear, without the need of replacing the entire stepping gearing system. The shaft inputs and outputs to the eccentric dual stepping gear roller bearing system may also be reversed to produce increasing outputs, where torque resistance is light because of the large gear reduction ratios.

This eccentric dual stepping gear roller bearing system has been employed with various motor reduction drive systems. In one application, the shaft of a 1700 rpm mixer was affixed to the stepping gearing system to reduce the output to 10:1. In another application, the stepping gear roller bearing system was employed in a pulley with a 500:1 reduction. Thus the differential invention adapted with an eccentric dual stepping gear roller bearing system provides a reduction gearing system from 10:1 to 500:1 for use with a wide variety of applications.

The gearless differential has no gears, is of simple construction, and is adapted for many uses, but in particular with a motor driven wheelbarrow or device with wheels to provide traction during turning as the inner turning wheel is disengaged to prevent slippage.

The gearless differential thus distributes power from a motor to two follower shafts with first ends connected to opposite wheels and second ends to opposed outer disks held in position with a journal mounted casing surrounding output differential disks with corresponding identical triangular raceways surrounding the central drive disk there between. The central drive disk has equidistant radial slots holding cylinders or roller bearings to radially reciprocate as they race along the raceways in a slippage mode where one wheel loses traction. In a drive mode, the central drive disk power input drives both outer disks connected to the two follower shafts transferring torque evenly to both wheels so there is no movement of the roller bearings or cylinders in the raceways.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exploded perspective view of the gearless differential.

FIG. 2 is a side view of the differential disk output of the embodiment shown in FIG. 1.

FIG. 3 is an cross-sectional view of the differential disk output shown in FIG. 2.

FIG. 4 is a perspective view of the gearless differential of FIG. 1 distributing power from a motor to two follower shafts connected to opposite wheels.

FIG. 5 is an exploded perspective view of the gearless differential of FIG. 1.

FIG. 6 is a perspective view of the gearless differential and eccentric dual stepping gear reducer of FIG. 5 distributing power from a motor to two follower shafts connected to opposite wheels.

FIG. 7 is a side view of another regular polygonal shaped raceway.

### DETAILED DESCRIPTION OF THE INVENTION

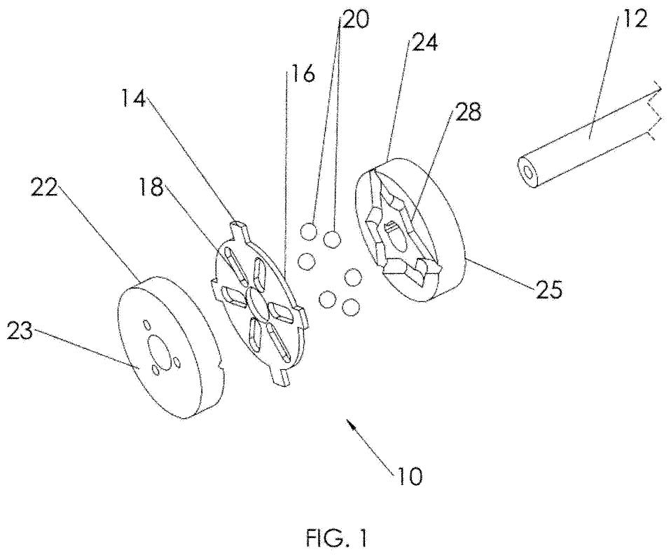

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the gearless differential of the present invention, as represented in FIGS. 1 through 3, is not intended to limit the scope of the invention, as claimed, but is merely representative of presently preferred embodiments of the invention.

FIG. 1 is an exploded perspective view of the gearless differential of the invention 10. An axle pin 12 has rotatably mounted thereon a central drive disk 14 having a perimeter with structure 16 driven by a motor drive chain or pulley. It has 6 equidistant radial slots 18 into which centers of roller bearings 20 radially reciprocate.

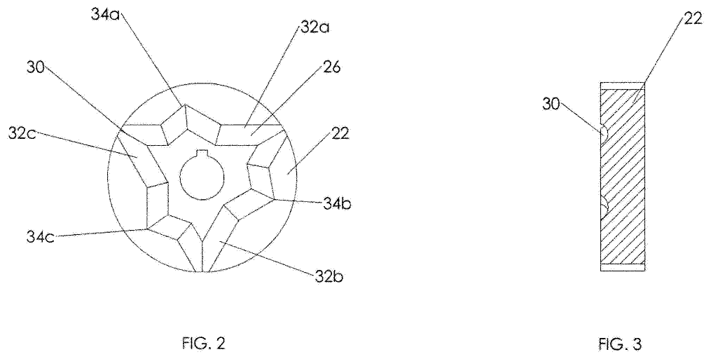

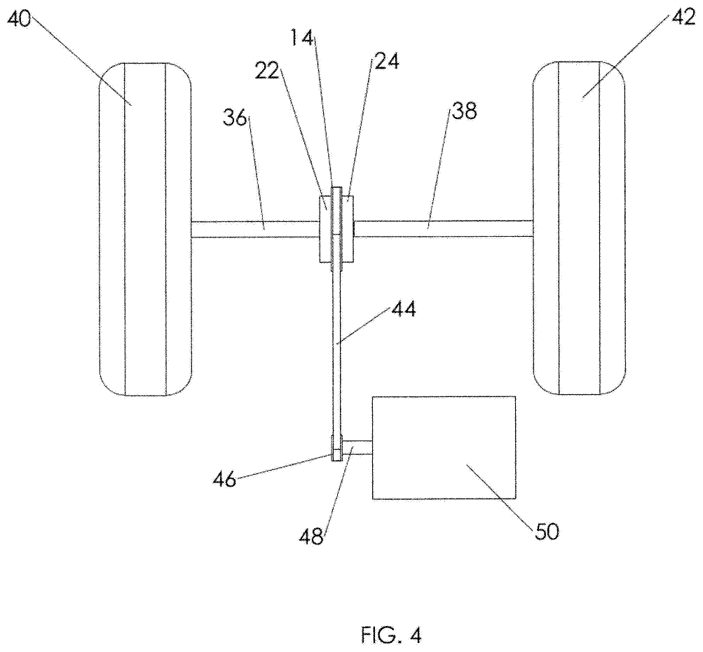

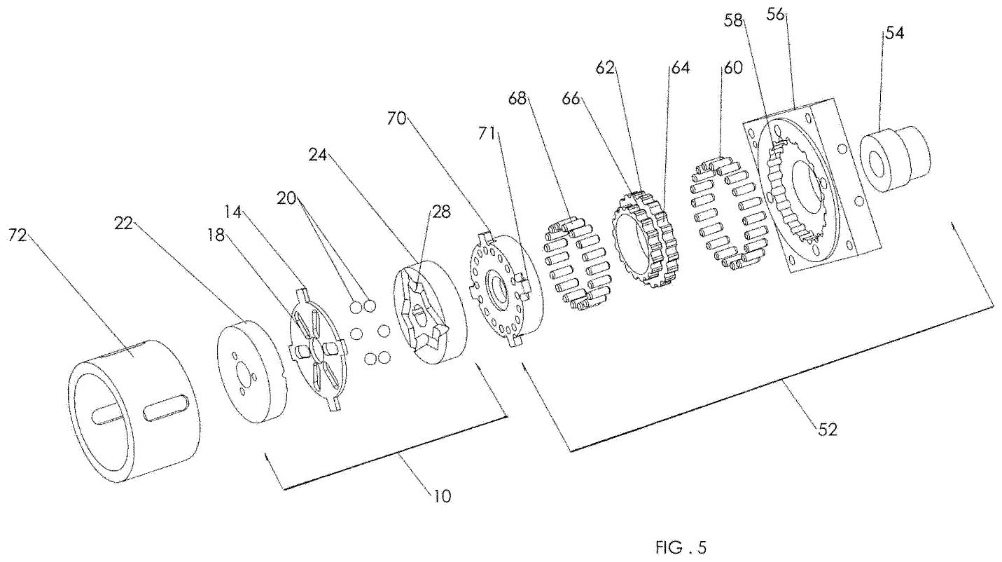

The central drive disk 14 is located between two opposed identical corresponding outer disks 22, 24 shown as left side and right side output differentials rotatably mounted on each side of the central drive disk 14 to rotate on the axle pin 12. Their exteriors 23, 25 are each adapted to be affixed to a follower shaft 36, 38 shown in FIG. 4 each connected to respective opposite wheels 40, 42. The outer disks 22, 24 have identical interiors each with corresponding aligned triangular shaped raceways 26, 28 shown in FIGS. 1 and 2 with vertices 30 aligned where each triangular side 32a, 32b, 32c of the raceways 26, 28 have an asymmetric extension raceway section 34a, 34b, 34c as shown in FIG. 2, which is a side view of the differential disk output. The opposed raceways 26, 28 are sized to accommodate ends of the slotted ball bearings 20 to race along the raceways 26, 28 as they reciprocate radially in the central drive disk 14 radial slots 18 in a slippage mode where one wheel loses traction. In the drive mode, the central drive disk 14 power input drives both outer disks 22, 24 connected to the two follower shafts 36, 38 transferring torque evenly to both wheels 40, 42 with no movement of the roller bearings 20 in the raceways 26, 28.

FIG. 4 is a perspective view of the gearless differential 10 of FIG. 1 distributing power from a motor's 50 shaft 48 to a sprocket 46 driving a chain 44, which drives the drive differential disk 14 powering two follower shafts 36, 38 with ends connected to the exteriors 23, 25 of the outer disks 22, 24 and the opposing wheels 40, 42.

FIG. 5 is an exploded perspective view of the gearless differential 10 of FIG. 1 associated with speed reduction unit 52 shown as a stepping gear embodiment of the invention 10 described above. The motor input to the reduction drive unit 54 enters the stepping gear 52 and is reduced before activating the drive differential 10.

The stepping gear 52 has a frame 56 with an interior 58 adapted to rotatably hold a plurality of hardened dowels 60, which interact with a walking gear 62 exterior track 64, The walking gear 62 interior track 66 accommodates two less hardened dowels 68, which drive the output walking ball reduction 70. The output walking ball reduction 70 has sprockets 71, associated with the central drive disk 14 to drive the same via a shifting cage 72 to engage and disengage the differential 10.

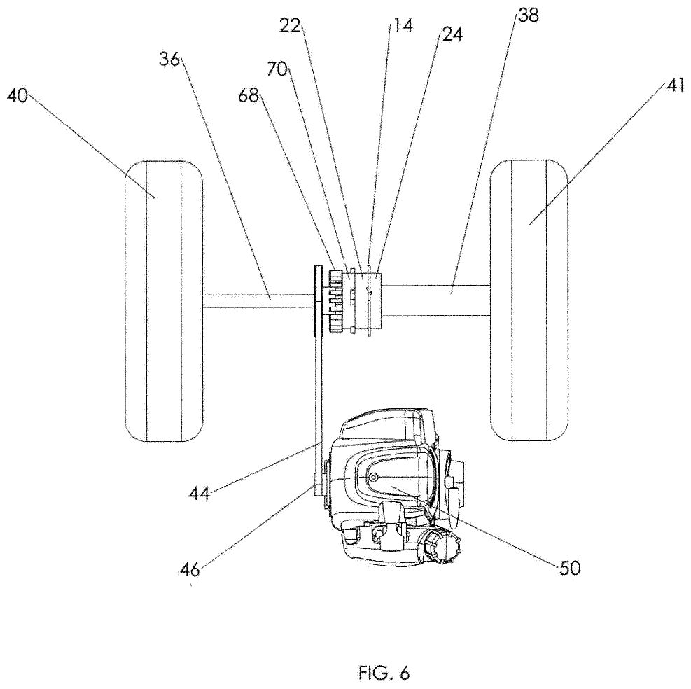

FIG. 6 is a perspective view of the gearless differential of FIG. 5 distributing power from a motor to two follower shafts connected to opposite wheels.

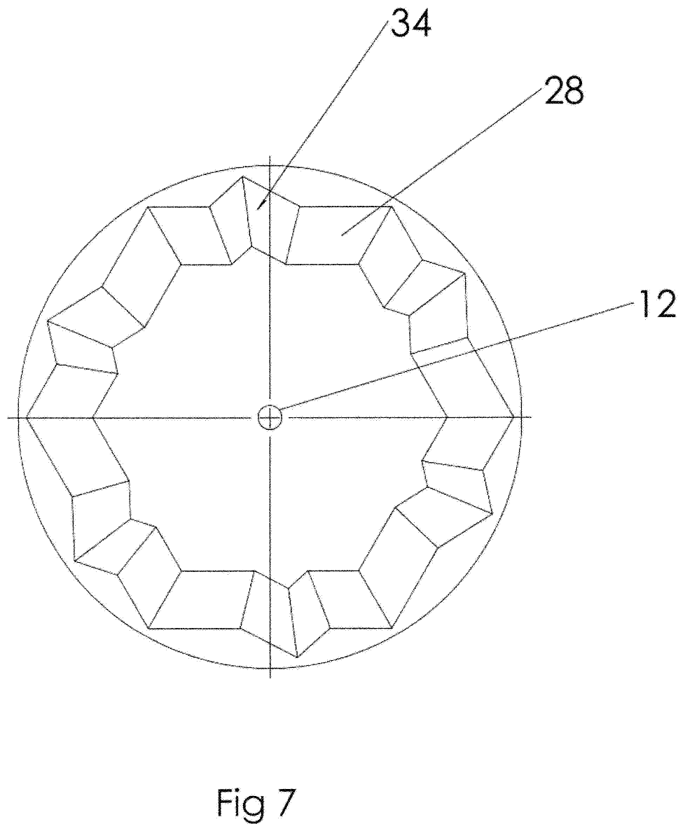

FIG. 7 is a side view of another regular polygonal shaped raceways 26, 28 shown as a hexagram centered around the axle pin 12 may be used, which has is an extension 34 of the raceway path that is not symmetrical around a radial line of the geometric shape for the ends of the twelve roller bearings 20 to travel.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

We claim:

1. A gearless differential for distributing power from a motor to two aligned follower shafts connected to opposite wheels to permit the two aligned follower shafts to rotate differently comprising:
a. an axle pin,
b. a central drive disk rotatably centrally mounted on the axle pin having perimeter structure adapted to be rotatably driven by a motor and having six or more equidistant radial slots,
c. one cylinder or roller bearing with center portions and extension portions placed into each radial slots such that the cylinders or roller bearings are held by their center portions to radially reciprocate, and
d. two opposed corresponding outer disks rotatably coaxially mounted on each side of the central drive disk on the axle pin with exterior faces affixed to each follower shaft; and interior faces with corresponding aligned regular polygonal shaped raceways proximate the radial slots where at least one regular side of the raceway has an off-center extension section that is not symmetrical around a radial line of the geometric shape, the opposed raceways sized to accommodate the extension portions of the cylinders or roller bearings to race along the raceways when reciprocating in the radial slots in a slippage mode where one wheel loses traction retarding equal rotation of one of the outer disks; and in a drive mode, the central drive disk power input drives both outer disks to rotate similarly for the two follower shafts to transfer torque evenly to both wheels so there is no movement of the cylinders or roller bearings in the raceways.

2. A gearless differential according to claim 1, wherein the regular polygonal shaped raceway is an equilateral triangle where each triangular side of the raceway has an off-center extension section, the opposed raceways sized to accommodate the extension portions of the cylinders or roller bearings to race along the raceways when reciprocating in the radial slots in a slippage mode where one wheel loses traction retarding equal rotation of one of the outer disks; and in a drive mode, the central drive disk power input drives both outer disks to rotate similarly for the two follower shafts to transfer torque evenly to both wheels so there is no movement of the cylinders or roller bearings in the raceways.

3. A gearless differential according to claim 1, wherein a motor drive chain or pulley is driven by the motor, and the central drive disk structure comprises a perimeter adapted to interact with and be rotated by the action of the motor drive chain or pulley.

4. A gearless differential according to claim 1, including an eccentric dual stepping gear roller bearing system affixed to the motor to regulate rotational output to the central drive disk comprising:
a. an eccentric input drive shaft,
b. an output shaft,
c. a gear ring with a portal sized to accommodate the output shaft and an affixed output gear defining a cylindrical interior to accommodate the output gear and a stepping gear, including peripheral structure to hold around the cylindrical interior a circular exterior row of a plurality of roller bearings in fixed equidistant positions with exposed roller surfaces surrounding the shaft portal,
d. an output gear attached to the output shaft is positioned to fit and rotate within the gear ring interior with structure defining a cylindrical interior of lesser diameter than that of the exterior row of the gear ring adapted to hold a circular interior row of a plurality of roller bearings in fixed equidistance circular positions around the output gear interior at a different plane relative to the exterior row of roller bearings; the number and diameter of the interior row of roller bearings less than the number and diameter of exterior row of roller bearings,
e. an eccentric stepping gear with exterior and interior stepping gears having different diameters with differing numbers of gear teeth structured to accommodate roller bearings joined off-center on top of one another and eccentrically attached at a selected throw to the eccentric input drive shaft to position the exterior and interior eccentric stepping gears within the cylindrical interior of the gear ring so that the exterior stepping gear teeth contact and push against the exterior row of roller bearings in a stepping motion causing the joined interior stepping gear teeth to push against and move the interior row of ball bearings in a stepping motion to rotate the output gear at a reduced output gear ratio, and
f. encasement structure with portals to accommodate the eccentric input drive shaft and output drive shaft leading into an interior structured to position and operably secure within the interior the eccentric stepping gear, the gear ring, and output gear operably associated with the eccentric drive shaft and output drive shaft to effectuate gear reduction.

5. A gearless differential according to claim 4, wherein the output gear rotates either in the same or in the opposite direction of the drive shaft depending upon whether the interior stepping gear contacts the interior or exterior surfaces of the interior row of roller bearings

6. A gearless differential according to claim 4, wherein the roller bearings are ball bearings.

7. A gearless differential according to claim 4, wherein the number of roller bearings in the exterior row are two more than the number of roller bearings in the interior row.

8. A gearless differential according to claim 4, wherein the size of the circular diameter of the interior row of roller bearings and the exterior row of roller bearings differs and is selected to provide the desired gear reduction.

9. A gearless differential according to claim 4, wherein the throw of the eccentric stepping gear is selected so that the stepping gear teeth contact approximately one-third of the roller bearings at a given time.

10. A gearless differential according to claim 4, wherein the gear reduction is in excess of 10:1.

11. A gearless differential according to claim 4, wherein the drive inputs to the eccentric input drive shaft and output drive shaft are reversed to provide an increased output gear ratio.
